(19) United States
(12) Patent Application Publication
(10) Pub. No.: US 2007/0142588 A1
(43) Pub. Date: Jun. 21, 2007

(54) Method for the synthesis of copolymers for producing polymethacrylimides

(75) Inventors: Jonas Scherble, Muhltal (DE); Peter Stein, Traisa (DE); Julian Corneliu Alupei, Neuwied (RO); Helmut Ritter, Wuppertal (DE); Sabine Schwarz-Barac, Gross-Gerau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GMBH & CO. KG

(21) Appl. No.: 10/568,971

(22) PCT Filed: Aug. 25, 2004
(86) PCT No.: PCT/EP04/09472

§ 371 Date: Oct. 3, 2006

(30) Foreign Application Priority Data
Aug. 29, 2003 (DE) 10340330.2

(51) Int. Cl. C08F 120/00

(52) U.S. Cl. 526/303.1; 526/319

(57) ABSTRACT

The invention relates to a method for producing polymethacrylimides in two steps: 1) radical copolymerization of (meth)acrylamides (A, (Me,H)HC=CHCONHR2) and alkyl(meth)acrylic esters (B) and optionally further ethylenically unsaturated monomers in the presence of an aqueous solvent. The monomers (A) include, in addition to acrylamide and methacrylamide, (meth)acrylamides that are substituted on their nitrogen group (R2<>H). The monomers (B) are the (meth)acrylic esters of secondary or tertiary alcohols, preferably tert. butylmethacrylate. 2) Thermal or catalytic reaction of the copolymers produced in 1) to polymethacrylimide or for R2<>H to N-substituted polymethacrylimides while alkenes are separated.

### FIELD OF THE INVENTION

The invention relates to copolymers based on (meth)acrylamides and (meth)acrylates, which are prepared by free radical polymerization in a water-containing diluent. These copolymers can be used as moulding material for the production of polymethacrylimide foams or moulding materials.

### PRIOR ART

Polymethacrylimides are used on an industrial scale in two forms of derivatization. First, poly-N-methylmethacrylimide (PMMI), which is available under the trade name PLEXIMID®, may be mentioned here. PMMI is a transparent plastic which has high heat distortion resistance and high UV stability. PMMI is used as an injection-mouldable moulding material, for example in the automotive sector. The preparation of PMMI moulding material is effected by a polymer-analogous reaction of polymethylmethacrylate moulding material with methylamine in an extruder.

The second polymethacrylimide type available on an industrial scale is the unsubstituted variant, i.e. no N-alkylation is present. This is therefore simply referred to as polymethacrylimide (PMI). The preparation is effected by the casting method, and PMI, in contrast to PMMI, therefore has high degrees of polymerization and is no longer fusible. PMI is widely used as a creep-resistant foam having high heat distortion resistance in sandwich constructions and is available under the trade name ROHACELL®.

The production of PMI foam is effected by the casting method (DE 3346060). Here, the monomers methacrylic acid and methacrylonitrile are mixed with initiators, blowing agents and optionally other monomers or additives and are introduced into a chamber comprising glass and/or metal plates which are held by a sealing cord at a certain distance. This chamber is lowered into a water bath having a defined temperature, and the comonomer obtained is converted into a polymethacrylimide in a second step by heating to temperatures between 150° C. and 250° C. What is problematic here is that the polymerization rate of methacrylic acid is substantially higher than that of methacrylonitrile, and hence the methacrylic acid reacts first during the polymerization so that a mixture of copolymers having substantially different compositions is obtained. Furthermore, the removal of the heat of polymerization in the casting method is difficult. Particularly with increasing polymer thickness (>20 mm), an uncontrolled polymerization may occur in the case of insufficient heat removal or too high a polymerization temperature and results in destruction of the material and possibly also of its immediate vicinity. The chosen polymerization temperatures and therefore polymerization rates must therefore be set so low in the chamber method that the duration of polymerization may be more than one week depending on thickness.

JP 04170408 and EP532023 describe the production of PMI foams. First, a copolymer of tert-butyl methacrylate, methacrylic acid and methacrylonitrile is prepared by mass polymerization. By using tert-butyl methacrylate, which eliminates isobutene on heating, it is possible to dispense with the addition of further blowing agents. This method, too, has two disadvantages: first, it is, as above, a casting method, which entails the problems with heat removal which have already been discussed. Secondly, the claimed compositions based on methacrylonitrile do not permit substitution of the imide hydrogen atom by other functional groups.

A further known method which could solve some of the abovementioned problems is the preparation of N-substituted polymethacrylimides in a water-containing diluent in the presence of cyclodextrins, which preparation is described in WO03/033556. However, the method described here has the disadvantage that the cyclodextrins required for the polymerization have to be used in relatively high concentrations of 150 mol %, based on 100 mol % of monomers, or more and then have to be separated from the polymer by a complicated procedure. Moreover, unsubstituted methacrylamide cannot be used since this monomer is too polar to form an inclusion compound with the cyclodextrins.

### OBJECT

It is therefore an object to develop a process for the preparation of a moulding material which can be further processed by heating to give a PMI foam. The process should ensure sufficient heat removal and thus permit the preparation of large amounts in a short time. Furthermore, the process should enable the possibility of substitution of the imide hydrogen atom of polymethacrylimide in order to influence the foam properties in a targeted manner by the choice of the side chains. Not least, it is intended, in the course of the process, to react monomers which, in contrast to the comonomer pair methacrylic acid/methacrylonitrile, have a comparable reactivity.

In the present invention, it is therefore preferably intended to use monomers which give ideally random copolymers (r₁≈1, r₂≈1, r₁ and r₂ are the copolymerization parameters) or even tend to alternating copolymers (r₁, r₂≈0). In order to avoid complicated purification steps of the polymer, it is moreover intended to dispense with the use of cyclodextrins.

Achievement

The abovementioned objects can be achieved by a precipitation polymerization or a suspension polymerization of the monomers in the presence of an aqueous diluent.

By carrying out the polymerization in the presence of an aqueous phase, excellent heat removal is ensured, owing to the high heat capacity of the water, in particular in comparison with the casting polymerization mentioned.

In a process according to the invention,

(meth)acrylamides H₂C═CR1CONHR2 (A)

and alkyl (meth)acrylates H₂C═CR¹COOR⁵ (B)

are copolymerized in the presence of a diluent (C).

The group consisting of the (meth)acrylamides (A) (R¹=H, CH₃) also includes N-substituted (meth)acrylamides (R2<>H) in addition to water-soluble methacrylamide. R2 may be an alkyl or aryl radical having up to 36 C atoms, which may additionally contain oxygen, nitrogen, sulphur and phosphorus atoms in the form of typical organic functionalities, such as, for example, an ether, alcohol, acid, ester, amide, imide, phosphonic acid, phosphonic ester, phosphoric ester, phosphinic acid, phosphinic ester, sulphonic acid, sulphonic ester, sulphinic acid or sulphinic ester function, silicon, aluminium and boron atoms or halogens, such as fluorine, chlorine, bromine or iodine. The following may be mentioned as examples of R2, without being restricted thereto: methyl, ethyl, propyl, 2-propyl, butyl, tert-butyl, hexyl, ethylhexyl, octyl, dodecyl, octadecyl, —R3—PO(OR4)2, where R3 is an alkyl radical having up to 12 C atoms and R4 is an alkyl having up to 4 C atoms, methylenedimethylphosphonate, methylenediethylphosphonate, methylenediisopropylphosphonate. Furthermore, mixtures of different methacrylamides may also be used. In addition to tert-butyl methacrylate (R5=tert-butyl), for example, isopropyl methacrylate (R5=isopropyl), sec-butyl methacrylate (R5=isobutyl) or methacrylates of longer-chain secondary or tertiary alcohols (R5=alkyl) may also be used as branched alkyl methacrylates (B). It is also possible to use the corresponding alkyl acrylates (R1=H) or mixtures of said monomers. By copolymerization with one or more further ethylenically unsaturated monomers, the chemical and physical properties of the polymers can be varied.

The polymerization of the monomers (A) and (B) is effected by a precipitation polymerization or a suspension polymerization method in an aqueous medium (C), preferably in water. In the present context, the term aqueous medium is to be understood as meaning mixtures of water and organic liquids miscible therewith. Such organic liquids are, for example, glycols, such as ethylene glycol, propylene glycol, block copolymers of ethylene oxide and propylene oxide, alkoxylated C₁- to C₂₀-alcohols, furthermore methanol, ethanol, isopropanol and butanol, acetone, tetrahydrofuran, dimethylformamide, N-methylpyrrolidone or mixtures. If the polymerization is effected in mixtures of water and water-miscible solvents, the amount of water-miscible solvents in the mixture is up to 45% by weight. Preferably, however, the polymerization is carried out in water.

The precipitation polymerization or suspension polymerization of the monomers is usually effected in the absence of oxygen at temperatures of 10 to 200° C., preferably 20 to 140° C. The polymerization can be carried out batchwise or continuously. Preferably, at least a part of the monomers, initiators and optionally regulators are uniformly metered into the reaction vessel during the polymerization, it also being possible to effect the mixing of the components continuously or batchwise outside the reaction vessel. The monomers and the polymerization initiator can, however, be initially introduced in relatively small batches into the reactor and polymerized, and if necessary sufficiently rapid removal of the heat of polymerization has to be ensured by cooling.

Suitable polymerization initiators are the compounds which are usually used in free radical polymerization and, under the polymerization conditions, give free radicals, such as, for example, peroxides, hydroperoxides, peroxodisulphates, percarbonates, peroxoesters, hydrogen peroxide and azo compounds. Examples of initiators are hydrogen peroxides, dibenzoyl peroxide, dicyclohexylperoxodicarbonate, dilauryl peroxide, methyl ethyl ketone peroxide, acetylacetone peroxide, tert-butyl hydroperoxide, cumyl hydroperoxide, tert-butyl perneodecanoate, tert-amyl perpivalate, tert-butyl perpivalate, tert-butyl perbenzoate, lithium, sodium, potassium and ammonium peroxodisulphate, azobisisobutyronitrile, 2,2′-azobis(2-amidinopropane) dihydrochloride, 2-(carbamoylazo)isobutyronitrile and 4,4′-azobis-(cyanovaleric acid). The initiators are usually used in amounts of up to 15, preferably 0.02 to 10,% by weight, based on the monomers to be polymerized. The use of the known redox initiators, in which the reducing component is used in less than the molar stoichiometric amount, is also suitable. Known redox initiators are, for example, salts of transition metals, such as iron(II) sulphate, copper(I) chloride, manganese(II) acetate, and vanadium(III) acetate. Suitable redox initiators are furthermore reducing sulphur compounds, such as sulphites, bisulphites, thiosulphates, dithionites and tetrathionates of alkali metals and ammonium compounds or reducing phosphorus compounds in which the phosphorus has an oxidation number of 1 to 4, such as, for example, sodium hypophosphite, phosphorous acid and phosphites. Furthermore, mixtures of said initiators or initiator systems may also be used.

In order to control the molecular weight of the polymers, the polymerization can optionally be carried out in the presence of regulators. Suitable regulators are, for example, aldehydes, such as formaldehyde, acetaldehyde, propionaldehyde, n-butyraldehyde and isobutyraldehyde, formic acid, ammonium formate, hydroxylammonium sulphate and hydroxylammonium phosphate. Furthermore, it is possible to use regulators which contain sulphur in organically bound form, such as organic compounds having SH groups, such as thioglycolic acetic acid, mercaptopropionic acid, mercaptoethanol, mercaptopropanol, mercaptobutanol, mercaptohexanol, dodecyl mercaptan and tert-dodecyl mercaptan. Regulators which may be used are furthermore salts of hydrazine, such as hydrazinium sulphate. The amounts of regulators, based on the monomers to be polymerized, are 0 to 20, preferably 0.5 to 15%, by weight.

By heating the copolymer to 100-300° C., optionally under a nitrogen atmosphere or in vacuo, isobutene or other readily volatile elimination products of the alkyl ester units are obtained by thermal syn-elimination from the tert-butyl ester units (I). Some of the acid groups formed react further with neighbouring amido groups, and a copolymer comprising imide, anhydride, amide and remaining alkyl ester units (II) results. 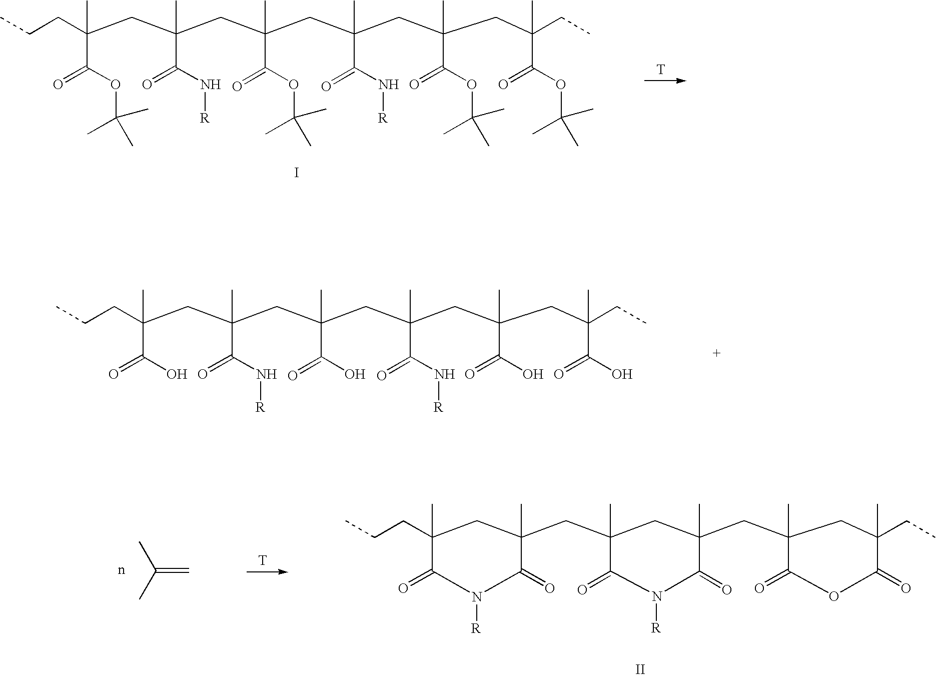
R=—H, -alkyl

The thermal syn-elimination is favoured over the depolymerization in the case of poly(tert-butyl methacrylate). The formation of methacrylic acid and/or methacrylic anhydride units prevents the depolymerization and hence the degradation to the respective monomers (G. Scott, Polymer Degradation and Stabilisation, 1. Polymers and Polymerisation, University Press, Cambridge, UK, 1985). The liberation of isobutene can also be catalyzed by unprotecting the carboxylic acid by photogenerated acid PAG, cf. Chem. Mater. 1996, 8, 2282-2290. The elimination can also be effected by acidic hydrolysis (K. Matsumoto et al., J. Polym. Sci. Part A Polym. Chem. 2001, Vol. 39, 86-92).

The alkenes liberated by the thermal elimination act as blowing agents. If the reaction is carried out in a thin layer, the blowing agent is eliminated by diffusion, and bubble-free, colourless films are obtained, cf. Angew. Makromol. Chem., II, 1970, 119, 91-108. Foaming can be achieved by producing a slab from the polymer prior to heating, for example by compression, or by melting the polymer under pressure so that the gaseous blowing agent formed remains dissolved in the polymer. The latter can be achieved, for example, by extrusion or by foam injection moulding. The polymerization of copolymers (meth)acrylates and (meth)acrylamides in the presence of an aqueous diluent, which polymerization is described in the context of the present invention, has the following advantages in comparison with the prior art:

As a result of the polymerization in the diluent water or in aqueous solvent mixtures, good removal of the heat of reaction is always ensured, so that the polymerization temperature can be kept within a narrow range even at high reaction rates.

The polymerization can be carried out economically under atmospheric pressure, but if required also under superatmospheric pressure or in vacuo.

Substantially dispensing with organic solvents is economical and, owing to the protection of resources, has ecological advantages. There are also advantages from the point of view of work safety since water is completely safe as a solvent and organic solvents in the mixture with water experience a substantial reduction of vapour pressure so that both the pollution of the room air and the fire and explosion risk are reduced.

Since the resulting copolymers are insoluble in water as the diluent and coolant, isolation of the polymer is possible in a technically simple and economical manner, for example by filtration or by centrifuging. Since the use of cyclodextrins can be dispensed with, there are no further purification steps of the polymer.

On heating the copolymers, a thermal syn-elimination of the secondary or tertiary alcohol esters takes place. The resulting alkenes act as blowing agents for foam formation. Foaming therefore takes place without additional use of blowing agents. Nevertheless, the use of additional blowing agents, such as, for example, azodicarbonamide or urea, for regulating the foam density is possible. The amount of added blowing agent is usually 0-20% by weight but may also be higher.

Compared with the copolymerization of methacrylonitrile and (meth)acrylates, the use of (meth)acrylamides as comonomers for the (meth)acrylates has the advantage that N-substituted imides are obtainable by substituting a hydrogen atom on the nitrogen of the (meth)acrylamide.

Polymers prepared according to the invention are suitable for the production of foams or of PMI moulding materials, including N-substituted ones.

### EXAMPLES

### Synthesis of poly(tert-butyl methacrylate-co-N-methacrylamide)

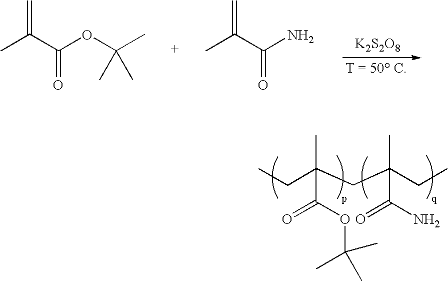

### Example 1

A 4 l three-necked flask equipped with a KPG stirrer and a nitrogen feed was evacuated three times and flushed with argon. 3400 ml of distilled water degassed in an ultrasonic bath were introduced into the flask. With the aid of an injection needle, argon was passed through the solution for 10 hours. 24.03 g (0.282 mol) of methacrylamide and 45.83 ml (0.282 mol) of tert-butyl methacrylate were then added under a countercurrent stream of argon. The reaction batch was degassed again several times with vigorous stirring and flushed with argon. After stirring for 1 h, the reaction mixture was heated to 40° C. 1 ml of the initiator solutions (redox initiators K₂S₂O₈ and Na₂SO₂O₅) was then pipetted into the reaction solution so that the initiator concentration, based on the monomers, was 1 mol %. The copolymerization was terminated after 4 h by cooling in an ice bath and by forcing in air. The precipitated copolymer was filtered off, washed with 3×100 ml of water and then dried in a high vacuum. The copolymer was obtained in a yield of 80%. According to NMR, the amide was incorporated in a proportion of 0.57. The weight average molecular weight was 774 400 g/mol, the number average molecular weight was 383 500 g/mol and the polydispersity was 2.0. The glass transition temperature of the copolymer is 125° C.

### Example 2

The preparation and polymerization were effected analogously to example 1. However, only 0.41 g (4.8 mmol) of methacrylamide and 0.68 g (4.8 mmol) of tert-butyl methacrylate were used. The reaction was carried out in 250 ml three-necked flask at a temperature of 50° C. The polymerization was terminated after 4 h. The copolymer was obtained in a yield of 30%. According to NMR, the amide was incorporated in a proportion of 0.53. The weight average molecular weight was 233 100 g/mol, the number average molecular weight was 107 900 g/mol and the polydispersity was 2.2. The glass transition temperature of the copolymer is 122° C.

### Example 3

A 100 ml three-necked flask equipped with a nitrogen feed was evacuated three times and flushed with nitrogen. The initiator solutions (redox initiators: 0.215 g of K₂S₂O₈ (0.8 mmol) and 0.15 g of Na₂S₂O₅ in 23 ml of water) were then introduced into the three-necked flask. The reaction batch was stirred under a nitrogen atmosphere and heated to the respective reaction temperature (table 1). 2.84 g (20 mmol) of tert-butyl methacrylate and 1.7 g (20 mmol) of methacrylamide were dissolved in 7 ml of methanol. This mixture was added dropwise in the course of 15 min to the initiator solution while a gentle nitrogen stream was passed through the solution. The copolymerization was terminated after the respective reaction time (table 1) by adding 0.1 g of methylhydroquinone as inhibitor. The precipitated copolymer was filtered off, washed with 200 ml of methanol, filtered off, washed again with 3×50 ml of methanol and then dried in a high vacuum and analyzed.

TABLE 1
Reaction conditions for copolymerizations
carried out in water/methanol mixture

| | Molar ratio of | | | | | |
|---|---|---|---|---|---|---|
| | tert-butyl | | | | | Amide |
| | methacrylate/ | K₂S₂O₈ | T | Reaction | Yield | content¹⁾ |
| No. | methacrylamide | [mol %] | [°C.] | time [h] | [%] | [mol %] |
| 3a | 1/1 | 2 | RT | 4 | 66 | 30 |
| 3b | 1/1 | 4 | RT | 4 | 62 | 23 |
| 3c | 1/1 | 4 | 40 | 4 | 70 | 20 |
| 3d | 1/1 | 4 | RT | 4 | 75 | 32 |

¹⁾From N content (elemental analysis, infrared spectroscopy)

### Example 4

A 100 ml three-necked flask equipped with a nitrogen feed was evacuated three times and flushed with nitrogen. 2.55 g (20 mmol) of methacrylamide were dissolved in 30 ml of degassed, distilled water. 2.84 g (30 mmol) of tert-butyl methacrylate were then added with stirring and in a countercurrent stream of nitrogen. The emulsion was stirred for 10 min under a nitrogen atmosphere and then heated to the respective reaction temperature. The copolymerization was initiated by adding the initiators (0.27 g (1 mmol) of K₂S₂O₈ and 0.19 g (1 mmol) of Na₂S₂O₅). The copolymerization was terminated after the respective reaction time (table 2) by adding 0.1 g of methylhydroquinone as inhibitor. The precipitated copolymer was filtered off, washed with 200 ml of methanol, filtered off, washed again with 3×50 ml of methanol and then dried in a high vacuum and analyzed.

TABLE 2
Reaction conditions for copolymerizations
carried out in water

| | Molar ratio of | | | | | |
|---|---|---|---|---|---|---|
| | tert-butyl | | | | | Amide |
| | methacrylate/ | K₂S₂O₈ | T | Reaction | Yield | content¹⁾ |
| No. | methacrylamicie | [mol %] | [° C.] | time [h] | [%] | [mol %] |
| 4a | 1/1 | 2 + 2 | 20 | 24 | 86 | 36 |
| 4b | 1/1.5 | 2 | 20 | 24 | 90 | 49 |
| 4c | 1/1.5 | 2 | 40 | 8 | 80 | 54 |
| 4d | 1/1.5 | 2 | 50 | 6 | 78 | 48 |

¹⁾From N content (elemental analysis, infrared spectroscopy)

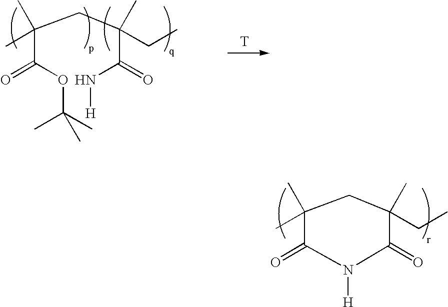

### Examples 5-9

### Foaming of the Copolymer from Example 1

The copolymer from example 1 was finely powdered and processed to give tablets having a diameter of 12.5 mm (examples 5, 8, 9) or 40 mm (examples 6, 7). The tablets were foamed by heating under the conditions stated in table 3. The composition of the copolymer foam was determined by NMR and the glass transition temperatures by DSC.

TABLE 3
Foaming of the copolymer from example 1

| | | Mass | Imide/amide/ | | |
|---|---|---|---|---|---|
| | Foaming | loss | anhydride | T_{g} | Density |
| No. | min/° C. | % by wt. | mol % | ° C. | kg/m³ |
| 5 | 130/190 | 25 | 23/22/55 | 125 | 443 |
| 6 | 120/250 | 52 | 73/0/27 | 213 | 274 |
| 7 | 115/250 | 51 | 78/0/22 | 214 | 252 |
| 8 | 42/240 | 42 | 71/0/29 | 211 | 600 |
| 9 | 95/250 | 71 | 58/0/42 | 215 | 500 |

### Examples 10-12

### Foaming of the Copolymer from Example 2

The copolymer from example 2 was finely powdered and processed to give tablets having a diameter of 12.5 mm. The tablets were foamed by heating under the conditions stated in table 4. The composition of the copolymer foam was determined by NMR, the molecular weights by volume exclusion chromatography based on PS standards and the glass transition temperatures by DSC.

TABLE 4
Foaming of the copolymer from example 2

| | | Mass | | | | |
|---|---|---|---|---|---|---|
| | | loss | Imide/amide/ | | | |
| | Foaming | % by | anhydride | M_{w}/Mₙ | T_{g} | Density |
| No. | min/° C. | wt. | mol % | kg/mol | ° C. | kg/m³ |
| 10 | 92/220 | 26 | | 23/12.4 | 163 | 264 |
| 11 | 56/250 | 37 | | 36.8/11.7 | 153 | 334 |
| 12 | 192/215 | 47 | 73/0/27 | 21.9/9.1 | 210 | |

### Comparative Example 1

330 g of isopropanol and 100 g of formamide were added as blowing agents to a mixture of 5700 g of methacrylic acid, 4380 g of methacrylonitrile and 31 g of alkyl methacrylate. Furthermore, 4 g of tert-butyl perpivalate, 3.2 g of tert-butyl per-2-ethylhexanoate, 10 g of tert-butyl perbenzoate, 10.3 g of cumyl perneodecanoate, 22 g of magnesium oxide, 15 g of mould release agent (PAT 1037a) and 0.07 g of hydroquinone were added to the mixture.

This mixture was polymerized for 68 h at 40° C. and in a chamber formed from two 50×50 cm glass plates and an 18.5 mm thick edge seal. The polymer was then subjected to a heating programme ranging from 32° C. to 115° C. for 32 h for the final polymerization. The subsequent foaming was effected for 2 h 25 min at 205° C. The foam thus obtained had a density of 235 kg/m³.

### Comparative Example 2

A foam having a density of 71 kg/m³ was produced according to DE 33 46 060, 10 parts by weight of DMMP having been used as a flameproofing agent. For this purpose, 140 g of formamide and 135 g of water as a blowing agent were added to a mixture of equal molar parts of 5620 g of methacrylic acid and 4 380 g of methacrylonitrile. Furthermore, 10.0 g of tert-butyl perbenzoate, 4.0 g of tert-butyl perpivalate, 3.0 g of tert-butyl per-2-ethylhexanoate and 10.0 g of cumyl perneodecanoate as initiators were added to the mixture. In addition, 1000 g of dimethyl methanephosphonate (DMMP) as a flameproofing agent were added to the mixture. Finally, the mixture contained 20 g of mould release agent (MoldWiz) and 70 g of ZnO and 0.07 g of hydroquinone.

This mixture was polymerized for 92 h at 40° C. in a chamber formed from two 50×50 cm glass plates and a 2.2 cm thick edge seal. The polymer was then subjected to a heating programme ranging from 40° C. to 115° C. for 17.25 h for the final polymerization. Subsequent foaming was effected for 2 h at 215° C.

The foam thus obtained had a density of 71 kg/m³.

### Comparative Example 3

For this purpose, 140 g of formamide and 135 g of water as blowing agents were added to a mixture of 5700 g of methacrylic acid and 4300 g of methacrylonitrile. Furthermore, 10.0 g of tert-butyl perbenzoate, 4.0 g of tert-butyl perpivalate, 3.0 g of tert-butyl per-2-ethylhexanoate and 10 g of cumyl perneodecanoate as initiators were added to the mixture. In addition, 1000 g of dimethyl methanephosphonate (DMMP) as a flameproofing agent were added to the mixture. Finally, the mixture contained 15 g of mould release agent (PAT) and 70 g of ZnO and 0.07 g of hydroquinone.

This mixture was polymerized for 92 h at 40° C. in a chamber formed from two 50×50 cm glass plates and a 2.2 cm thick edge seal. The polymer was then subjected to a heating programme ranging from 40° C. to 115° C. for 17.25 h for the final polymerization. The subsequent foaming was effected for 2 h at 220° C.

The foam thus obtained had a density of 51 kg/m³.

### Comparative Example 4

The procedure was substantially as in the case of comparative example 2, except that the foaming was effected at 210° C. and the density of the foam obtained was then 110 kg/m³.

1. A process for the preparation of copolymers comprising copolymerizing monomers (A) and (B) wherein monomer (A) is a (meth)acrylamide of the formula I
H₂C═CR¹CONHR² I
in which:
R¹═H or CH₃,
R² is an alkyl or aryl radical having up to 36 C atoms, which may additionally contain oxygen, nitrogen, sulphur and phosphorus atoms in the form of typical organic functionalities, which includes an ether, alcohol, acid, ester, amide, imide, phosphonic acid, phosphonic ester, phosphoric ester, phosphinic acid, phosphinic ester, sulphonic acid, sulphonic ester, sulphinic acid or sulphinic ester function, silicon, aluminium and boron atoms or halogens, including fluorine, chlorine, bromine or iodine, may denote methyl, ethyl, propyl, 2-propyl, butyl, tert-butyl, hexyl, ethylhexyl, octyl, dodecyl, octadecyl or
R3-PO(OR4)2; where R3 is an alkyl radical having up to 12 C atoms and R4 is an alkyl having up to 4 C atoms, methylenedimethylphosphonate or methylenediethylphosphonate and monomer (B) is an
alkyl (meth)acrylate (B) of the formula II
H₂C═CR¹COOR⁵ II
wherein R¹ has the abovementioned meanings and R⁵ is an isopropyl or tert-butyl or isobutyl, and R⁵ may also be a longer-chain secondary or a longer-chain tertiary alcohol
in a water-containing diluent and optionally further monomers copolymerizable with (A) or (B), wherein the monomers (A) and (B) are used in a molar ratio of 1:10 to 10:1.

2. The process according to claim 1, wherein the monomers (A) and (B) are used in a molar ratio of 1:5 to 5:1.

3. The process according to claim 1, wherein the monomers (A) and (B) are used in a molar ratio of 1:2 to 2:1.

4. The process according to claim 1, wherein the diluent is a mixture of methanol, water and optionally further organic solvents.

5. The process according to claim 1, wherein the diluent comprises more than 50% by weight of water.

6. The process according to claim 1, wherein the diluent comprises more than 80% by weight of water.

7. The process according to claim 1, wherein the monomer (B) is tert-butyl methacrylate.

8. The process according to a claim 1, wherein the copolymer is converted into a polymethacrylimide by heating with elimination of gaseous reaction products.

9. The process according to claim 1, wherein the alkyl esters of the copolymer are first cleaved by catalysis and the reaction product is converted into a polymethacrylimide in a second step by heating.

10. A composition comprising a copolymer produced according to the process as claimed in claim 1 and additional blowing agents.

11. The composition according to claim 10, wherein the blowing agent is at least one selected from the group consisting of an alcohol having 3-8 carbon atoms, urea, N-monomethylurea, N,N′-dimethylurea, formic acid, formamide and water.

12. A process for the production of a foam, wherein a copolymer produced according to the process as claimed in claim 1 is moulded to give a moulding and then foamed by heating.

13. A general moulding material comprising a copolymer produced according to the process as claimed in claim 1.

14. A process for the production of foams comprising utilizing the general moulding material as claimed in claim 13.

15. A process for the production of foam bodies, wherein the general moulding material according to claim 13 is processed by foam extrusion or foam injection moulding.

16. A coating material comprising a copolymer produced according to the process as claimed in claim 1.

17. A membrane material comprising a copolymer produced according to the process as claimed in claim 1.

18. A sandwich construction comprising the foam produced by the process as claimed in claim 12.

19. A space craft, an aircraft, a water vehicle or a land vehicle comprising the foam produced by the process as claimed in claim 12.
